(19) United States
(12) Patent Application Publication
(10) Pub. No.: US 2019/0220945 A1
(43) Pub. Date: Jul. 18, 2019

(54) SYSTEM OF ONLINE GROUP ORDERING AND SERVING FOR HOME VISIT ROUTINE SERVICE THE METHOD THEREOF

(71) Applicant: Sung W. Jung, Vienna, VA (US)

(72) Inventor: Sung W. Jung, Vienna, VA (US)

(21) Appl. No.: 16/138,968

(22) Filed: Sep. 22, 2018

Related U.S. Application Data
(60) Provisional application No. 62/617,722, filed on Jan. 16, 2018.

(51) Int. Cl. G06Q 50/28; G06Q 30/02

(52) U.S. Cl. CPC G06Q 50/28; G06Q 30/0236

(57) ABSTRACT

An online and smart phone application-based home-visit maintenance-service and ordering and grouping method, and system are disclosed. The method and/or system converts individual orders from users into a group order in regard to the same geographical regions and the group order service time.

A method on a server for providing a discount service and a discount offer for a plurality of users based upon a geographical region over a communications network includes: receiving, via the communications network, a service request from a plurality of the users; calculating a discounted price or a discount rate for the service request based upon the number of requested service and the geographical region; and informing, via the communication network, the discounted price or the discount rate to at least one of the pluralities of the users.

### CROSS-REFERENCE TO RELATED APPLICATIONS

This Non-Provisional Patent Application claims the benefit of the filing dates of U.S. Provisional Patent Application Ser. No. 62/617,722, filed Jan. 16, 2018, entitled “ METHOD AND SYSTEM OF ON-DEMAND GROUP ORDERING AND SERVING FOR HOME VISIT ROUTINE SERVICE” which is herein incorporated by reference.

### BACKGROUND OF THE INVENTION

### 1. Field of the Invention

The present invention is generally related to online and smart phone applications (Herein a APP) that takes a service order from a registered user and forwards it to the service provider via internet networks.

More particularly, the present invention is a method of an electronic incentive system to encourage customers to join a group order at their demand. The automatic grouping of customers' service orders will reduce the cost of that particular service by minimizing the number of trips that a service provider makes to that particular geographic area.

### 2. Description of the Related Art

Current online and/or smart phone-based home visit maintenance services such as lawn mowing, leaf removal, snow blowing, driveway coating services receive a registered user's service request. Typically, a service provider performs a one-time service, or binds users with a fixed-term contract for the service. For most single service requests, the providers are required to visit multiple registered users at multiple sites in the geographical area on different days in order to serve their customers. Providers can also make predetermined recurring service plans and create service routes to reduce the number of service visits in the specific areas if the registered users have signed a long-term service contract.

It is difficult for single service providers to service customers efficiently because one-time service orders are geographically spread out and occur over long period of time. Hence, it is hard for providers to service them efficiently. Service providers can create more efficient service routes with recurring service orders by requiring customers to sign up for a specific long-term package deal. This prevents from taking advantage of other cheaper options that come up after they have committed to a package deal.

### SUMMARY OF THE INVENTION

The objective of the present invention to provide a method and a system of online group ordering for home visit maintenance services, so that a group of registered users can take advantage of a group discount for a particular service type without a long-term contract.

It is apparent that existing home visit maintenance services, which include but not limited to lawn mowing, leaf removal, snow blowing, and driveway coating services providers prefer to perform services within similar time frames in the geographical regions in order to minimize service trip distances and save on time and costs. Users who live in the same or neighbor geographical area will most likely need a service within similar time frames because of the cyclical nature of growing lawns, falling leaves, accumulating snow, and degrading driveways. The APP bundles multiple jobs requiring the same service type in a specific geographical area and deliver them on the same day.

The user may use the APP to request a service, such as lawn mowing, and the system may send a group discount offer to other users in that area via their smartphone APP or other electronic communication means. This allows registered users to take advantage of a group discount for service without a long-term commitment of that service.

For example, when the first user places an online service request via the smartphone application, a promotional electronic message (or push notification) for a group order discount will be sent to the other users in the geographical region. The more service orders may receive the better the promotional discount may be offered for the registered users via the smartphone application's push notification. After the time limit expired the service orders may be forwarded to a local service provider. The local service provider may make a single trip to that geographical region to perform the requested service for the users who have participated in the group discount in the same geographical region.

Aspect of the present invention, a method on a server for providing a discounted service and a discount offer for a plurality of users based upon a geographical region over a communications network, including: receiving, from mobile computers communicatively coupled with the communications network, enrollment data of a plurality of users, wherein enrollment data includes at least contact information and service location information of a user; receiving, via the communications network, a service request from a plurality of the users; calculating a first discounted price or a first discount rate for the service request based upon the number of requested service and the geographical region; and informing, via the communication network, the first discounted price or the first discount rate to at least one of the plurality of the users.

In accordance with an aspect of the present disclosure, the discount price or the discount rate is high if a greater number of the service are requested in the same geographical region.

In accordance with an aspect of the present disclosure, the discount price or the discount rate is determined by a trip distance among the plurality of users for providing the requested service.

In accordance with another aspect of the present disclosure, a method on a server for providing a discount service and a discount offer for a plurality of users based upon a geographical region over a communications network further includes: transmitting, via the communication network, a discount service offer to at least one of a plurality of potential users who does not requested the service yet.

Another aspect of the present disclosure is to provide a method on a server for providing a discount service and a discount offer for a plurality of users based upon a geographical region over a communications network further includes receiving, via the communication network, a service request from the at least one of the pluralities of potential users; calculating a second discounted prices or a second discount rates for the plurality of the potential users based upon the number of requested services in geographical regions; and informing, via the communication network, the second discounted price or the second discount rate to at least one of the requested pluralities of potential users.

Another aspect of the present disclosure is to provide a method on a server for providing a discount service and a discount offer for a plurality of users based upon a geographical region over a communications network further includes the calculating the second discounted price or the second discount rate for the service is determined based upon the number of requested services in the geographical region.

Another aspect of the present disclosure is to provide a method on a server for providing a discount service and a discount offer for a plurality of users based upon a geographical region over a communications network further include the discount price or the discount rate is high if more numbers of the service are requested in the same geographical region.

Another aspect of the present disclosure is to provide a method on a server for providing a discount service and a discount offer for a plurality of users based upon a geographical region over a communications network further include recalculating the first discounted price or the first discounted rate for the service request based upon the number of requested service and the geographical region; informing, via the communication network, the recalculated first discounted price or the recalculated first discount rate to the at least one of the pluralities of the users.

Another aspect of the present disclosure is to provide a method on a server for providing a discount service and a discount offer for a plurality of users based upon a geographical region over a communications network further include a requested service is any one of lawn mowing, leaf removal, snow blowing, driveway coating service.

Another aspect of the present disclosure is to provide a method on a server for providing a discount service and a discount offer for a plurality of users based upon a geographical region over a communications network further include requesting, via the communication network, at least one local service provider to perform the requested service.

Another aspect of the present disclosure is to provide a method on a server for providing a discount service and a discount offer for a plurality of users based upon a geographical region over a communications network further includes receiving, via the communication network, at least one photo related to service performed by the local service provider.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

Having thus described various aspects of the invention in general terms, reference will now be made to the accompanying drawings, which are not necessarily drawn to scale, and wherein:

FIG. 1A is a block diagram illustrating the network architecture of a system for providing a group discount for a particular service type over a communications network, in accordance with one embodiment of the present invention.

FIG. 1B illustrates the interface for registered user's APP pages according to an aspect of the present invention;

FIG. 2 illustrates a group discount offering and ordering system and processing flow how to an order and an electronic promotional message transmitted to the registered user's APP according to an aspect of the present invention;

FIGS. 3A-3D show how to count neighborhood orders according to an aspect of the present invention;

FIG. 4A shows a relationship between a group discount amount (%) and numbers of neighborhood count according to an aspect of the present invention;

FIG. 4B shows a summary of neighborhood order count per customers according to an aspect of the present invention;

FIG. 4C shows group discount rates for customers according to an aspect of the present invention;

FIGS. 5A-5B illustrate amounts of discounts/rates may be increased linearly as shown in FIG. 5A or increased with a saturation as shown in FIG. 5B-according to an aspect of the present invention;

FIG. 6 illustrates the interface for the service provider's APP pages according to an aspect of the present invention;

FIG. 7 illustrates a graphical user interface for a camera page in APP according to an aspect of the present invention; and

FIG. 8 illustrates a graphical user interface for a registered user's APP according to an aspect of the present invention.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In various embodiments of the present disclosure, the terminal may be referred to as a ‘system’, a ‘subscriber unit’, a ‘subscriber station’, a ‘mobile station’, a ‘remote station’, a ‘remote terminal’, a ‘mobile device’, a ‘user terminal’, a ‘terminal’, a ‘wireless communication device’, a ‘user agent’, a ‘user device’, or a ‘user equipment (UE)’. The terminal may be a cellular phone, a personal digital assistant (PDA), a handheld device with radio access capability, a computing device, a device connected to a wireless modem, and the like.

Various embodiments of the present disclosure are described with reference to the accompanying drawings. Detailed description of well-known functions and structures incorporated herein may be omitted to avoid obscuring the subject matter of the present disclosure. Further, the following terms are defined based on the functionality in the present disclosure, and may vary according to the intention of a user or an operator, usage, and the like. Therefore, the definition should be made based on the overall content of the present specification.

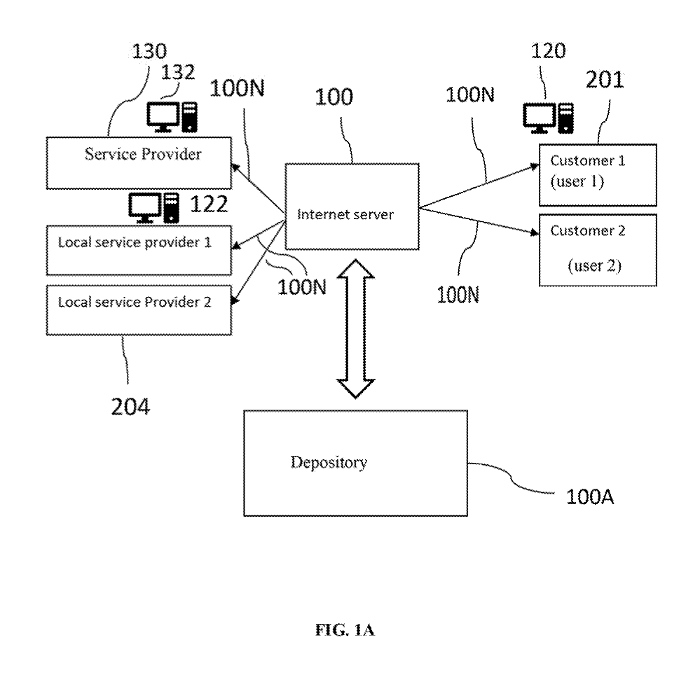

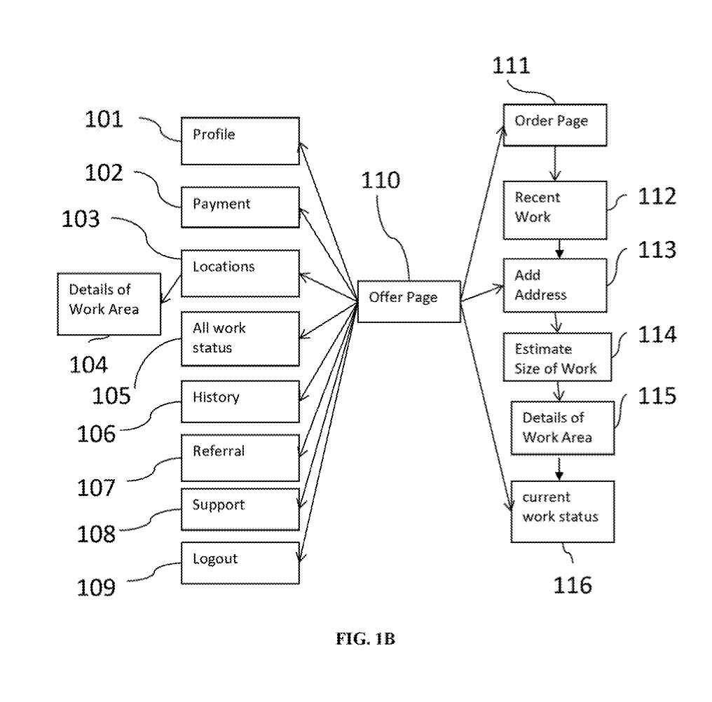

FIG. 1A may include mobile computers 120 and 122, which may be smart phones, mobile phones, tablet computers, handheld computers, laptops, or the like. Mobile computers 120 and 122 correspond to a customer 201 and a local service provider 204, respectively according to an aspect of the present invention.

A customer 201, also known as a user, may be a registered user, who wants to request a service to the service provider 130. The customer 201 may receive a group discount rate or price for the requested service based on the number of requested services in the same geographical region. The customer 201 means a user and may be a registered user. However, it is not necessary to be a registered user, but may be a guest user also available to receive the service if all required information is submitted.

The service provider computer 132 corresponds to the service provider 130, who may perform supervisory or administrative tasks on server 100. The service provider 130 may, for example, prepare and send group service discount offers to the customer 201 through a phone 120 of the customer 201. In addition, the service provider 130 may send an order to perform the requested service to the local service provider 204 through a phone 122 of the local service provider 204 if necessary.

The service provider's computer 132 may be a mobile computer, a desktop computer, a common computer terminal or the like. However, it is not limited thereto.

FIG. 1A further shows that the server 100 may include a database or a repository 100A, which may be a relational database comprising a Structured Query Language (SQL) database stored in a SQL server. Mobile phones 120 and 122 may download and install application software for receiving, requesting, or performing for the service in accordance with an aspect of the present invention, respectively.

However, it is also understood that the depository 100A may be located remotely from the server.

The depository 100A may include a record for the customer(s) 201 and the local service provider(s) 204. A user record may include: contact/identifying information for the customer, contact/identifying information for the local service provider, etc. A customer record may also include a unique identifier for each customer, a residential address for each customer and/or the requested service location of each customer.

Service history data, for example, may be stored in the database 104 and associated with a record for the customer.

The depository 100A may further include a record for each group discount offer created by a service provider 130, such as administrative provider 130. A group discount offer may include a service or service description, an image of the service, an example of discount rate or price, an expiration date and time for the offer, a current number of acceptances of the offer, computer program code that includes a countdown timer that counts down to the time at which the group discount offer expires, etc. In another embodiment, a group discount offer may include offering group discount service and receiving request the service to or from the prospective customer(s).

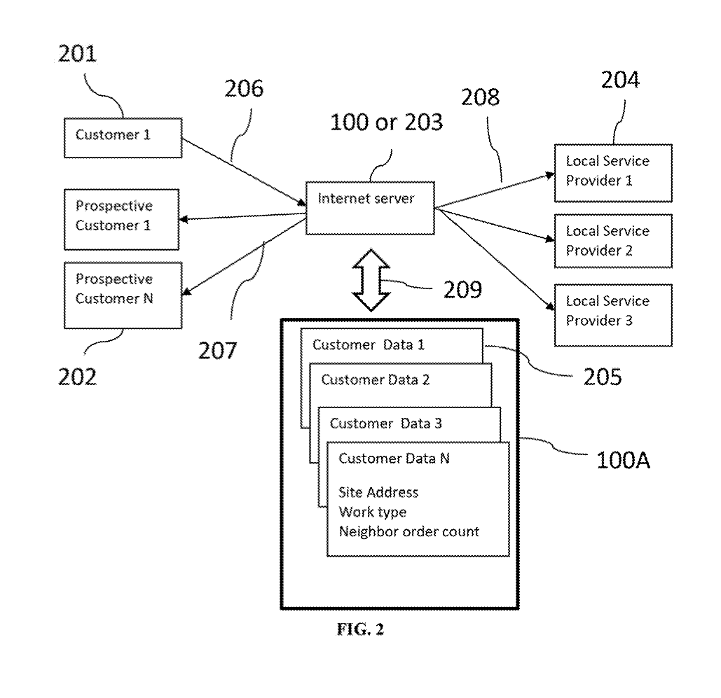

FIG. 1A shows wherein networked computing devices 120, 122 and 132 interact with a server 100, 203 shown in FIG. 2 and repository 104 over the network 100N according to an embodiment of the present invention. The server 100 includes a software engine that delivers applications, data, program code and other information to networked computing devices 120, 122 and 132. The software engine of server 100 may perform other processes such as audio and/or video streaming or other standards for transferring multimedia data in a stream of packets that are interpreted and rendered by a software application as the packets arrive. It should be noted that although FIG. 1 shows only three networked computing devices 120, 122 and 132, the system of the present invention supports any number of networked computing devices connected via network 100N.

In one embodiment of the present invention, the application provided by the server 100 of FIG. 1A is a client-server application having a client portion that may reside on a client computer (i.e., 120, 122 and 132) and a server application that may reside on the server 100. For example, the application can be a web interface that is accessed by a client computer via the network 100N. The application served by the server 100 may be written using any of the following technologies: CSS (Cascading Style Sheets), DOM (Document Object Model), JavaScript, XPCOM (Cross-Platform Component Object Model), XPConnect, XPI (Cross-Platform Installer), XUL (XML User Interface Language).

The server 100 may include program logic (not shown) including computer source code, scripting language code or interpreted language code that is compiled to produce computer instructions that perform various functions of the present invention. In one embodiment of the present invention, the program logic is a scripting language such as ECMAScript, CSS, XML (Extensible Markup Language), XSLT (Extensible Style-sheet Language Transformations), Javascript, AJAX (Asynchronous JavaScript and XML), XUL, JSP, PEW, and ASP (Active Server Pages). The program logic may reside on a client computer, the server 100 or any combination of the two.

Note that although the server 100 is shown as a single and independent entity, in one embodiment of the present invention, the functions of the server 100 may be integrated with another entity, such as one of the client computers Further, the server 100 and its functionality, according to a preferred embodiment of the present invention, can be realized in a centralized fashion in one computer system or in a distributed fashion where different elements are spread across several interconnected computer systems.

The network architecture of FIG. 1A in accordance with the principles of the present invention may give rise to various group discounting service arrangements. The customer 110 may, for example, request a group discount service via the application of the present invention. The customer 201 may also, for example, pay a service fee through the server 100 in exchange for the services provided by the service provider 130 or the local service provider 204.

Referring to FIG. 1B, according to an aspect of the present invention, a smartphone application, web application, or a software application (i.e., the APP) and related components is comprised of a set of functionalities of showing available services for registered user's locations, getting group discounts, managing a list of work site information, placing orders, reviewing work completion, and making payments. The APP communicates via some means of a physical communication layer (e.g., the internet connection) with a server (i.e., the HTTP/HTTPS server or a server with similar purpose).

The APP and a server further communicate using a proprietary communication mechanism over standard (i.e., TCP over IP protocol) or proprietary protocols, which implement the software system of the invention. The user APP, as shown in FIG. 1B, may include a profile 101, payment options 102, work site locations 103, details of each work site 104, work status 105, work history 106, referral 107, a user support 108, logout 109, offers 110, orders 111, recent work completed 112, a new address 113, estimating work area size 114, a work area detail page 115, current work status 116. The profile page 101 may store the user's login, name, email address and phone numbers. The payment option page 102 may encrypt and securely store payment option information such as credit card information, paypal/bank accounts, and other on-line payment options. The location list page 103 may maintain a list of user's work site locations. The site locations may be added and removed as the user desires, and also the details of site information 104 may be edited. The work status page 105 may report the status of all current work or recent work results of each service type per each user's work site. The history page 106 may show past performed service information including a location, a service type, a service date and time, a quote, a price, and/or other service related data as needed. The referral page 107 may show promotional messages and discount offers, and a list of phone contacts to forward the link to download the APP from an app store or a web site. The referral page 107 may create a referral message that can be sent to selected prospective users using contact information in a form of a mobile phone's text message and/or an email. However, it is not limited thereto. The support page or help page 108 may list frequently asked questions and answers that users may ask registered user services, and also has a text field to submit questions to user services.

The logout page 109 may ask for a confirmation of a user's logout, then close the network session, and delete the user's local data from the APP if the user agrees. The offer page 110 may show available service types, their price quotes, group discount amounts, registered users' order counts, and/or a remaining time for the discount offer for each user's work site. This data may be presented in graphical formats by displaying the locations on a map, graphical icons of the service types, numerical values of the price, the discount, and the order counts adjacent to each service type. The order page 111 may show a summary of a service order, including a work site address, work descriptions, regular price, registered users' order count, a list of discounts, a final price, and/or the photos of previously performed work results. When the user places a service order it is transmitted to the server, placed in a service queue (not shown), and also may initiate recalculating the group order discounts for the users. The user may view the photos for the before and after work from the providers on the recent work page 112 before placing an order.

A registered user may add an address for a new site on the add address page 113 by typing an address or tapping on the map. The geo-location on the map gets converted into a physical address and fills out the address field. After a new location is entered on the new site page 114, an area size of the new location may be estimated by either using on-line real-estate information providers or the user may enter the lot size. After the lot size is confirmed, the registered user may provide photos of a house, a yard, and a driveway, and also fills out a questionnaire about the existence of hazards such as fence, hills, pets, sprinklers, swimming pool, etc. After collecting the details of the new site 115, the new site location is recorded in the server and then available for the user to place a service order for the site. The registered user can find the work status for all their addresses listed on the current work status page 116.

FIG. 2 illustrates an online group ordering system according to an aspect of the present invention. The group order may be determined by the number of users' orders for the same service in the same or neighbor geographical region. It may be also understood that group discount may be applied to the user group having a short travel time between the user group even though the user group are not in the same geographical region. When a user, a customer 201 places a service order via the APP as shown in the FIG. 1B, the service order 206 from customer 1 is transmitted to an internet server 203 or 100 via the internet or network 100N. However, the service order may be transmitted not only the internet but also other communications such as a local area network (“LAN”), a wide area network (“WAN”), storage area network (“SAN”), personal area network (“PAN”), a metropolitan area network (“MAN”), a wireless local area network (“WLAN”), a virtual private network (“VPN”), a cellular or other mobile communication network, Bluetooth, Bluetooth low energy, NFC, or any combination thereof or any other appropriate architecture that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment. The server 203 may determine which all of the other users in the same or neighbor geographical region that are eligible for a group discount for that service using the information 209 stored in the repository 100A. The server 203 may send an electronic message offering a group order discount to the prospective customers 202 using their smartphone 120 by the smartphone's push notification 207, desktop application, and/or email accounts.

After the discount expires or the number of orders from the same or neighbor geographical region reach a specific limit, then the individual orders from each registered user in the same geographical region are bundled into a group order 208 for each service type. The group orders may be then forwarded to a local service provider 204 to generate a work order. Accordingly, in the case of an extraordinarily large job a group order for a particular service can be handled by several local providers 204.

Accordingly, a method on a server for providing a discount service and a discount offer for a plurality of users based upon a geographical region over a communications network, including receiving, from mobile computers communicatively coupled with the communications network, enrollment data of a plurality of users, wherein enrollment data includes at least contact information and service location information of a user; receiving, via the communications network, a service request from a plurality of the users; calculating a first discounted price or a first discount rate for the service request based upon the number of requested service and the geographical region; informing, via the communication network, the first discounted price or the first discount rate to at least one of the pluralities of the users according to an aspect of the present invention.

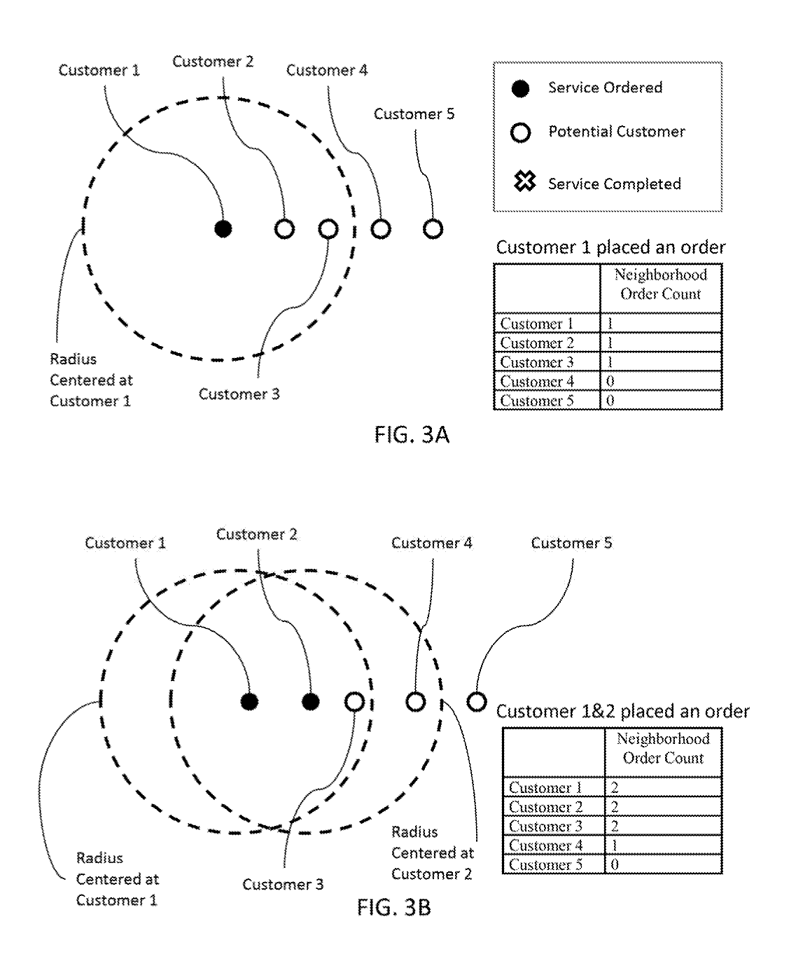

FIGS. 3A-3D show how to count neighborhood orders according to an aspect of the present invention.

FIG. 3A shows that the neighborhood order counts when the customer 1 places an service order. The prospective customers 2 and 3 are close to the customer 1, so their neighborhood counts may get increased by 1. The customer 1 has also 1 neighborhood count because including its own order as a neighborhood count.

FIG. 3B shows that the neighborhood order counts when the customer 1 and 2 places an order.

The Customer 1 is close to an order of the customer 2, so a neighborhood count of customer 1 is 2 (including its own order).

The Customer 2 is close to an order of the customer 1, so a neighborhood count of the customer 2 is 2 (including its own order).

The Customer 3 are close to the customers 1 and 2, so neighborhood counts of the customer 3 is 2.

The Customer 4 is only close to an order of the customer 2, so a neighborhood count of the customer 4 is 1.

FIG. 3C shows that the neighborhood order counts when the customer 1, 2, and 5 places an order.

The Customer 1 is close to an order the customer 2, so a neighborhood order count of the customer 1 is 2 (including its own order).

The Customer 2 is close to an order of the customer 1, so a neighborhood count of the customer 2 is 2 (including its own order).

The Customer 3 is close to orders of the customers 1, 2, and 5, so a neighborhood count of the customer 3 is 3.

The Customer 4 is close to orders of the customers 2 and 5, so a neighborhood count of the customer 4 is 2.

The Customer 5 is close to none of neighbor's orders, but it has its own order, so the neighborhood order count of the customer 5 is 1.

FIG. 3D shows that the neighborhood order counts when the customers 1 and 2 already received the service and the customer 5 places an order.

The Customers 1 and 2 already received the service, so neighborhood count of the customers 1 and 2 is 0, respectively.

The Customer 3 and 4 are close to an order of the customer 5, so neighborhood count of the customer 3 and 4 is 1, respectively.

The Customer 5 is close to none of orders, so neighborhood count of the customer 5 is 1 because it has its own order.

Accordingly, a system for the online group ordering and the incentive method thereof and for a specific service is provided according to an aspect of the present invention. When a user places a service order the system offers a group order discount to the other users in the same geographical region. When a plurality of users place the service orders a larger discount may be offered. Thus, a discount price or a discount rate may be determined by a number of users who requested the services in the same geographical region.

In addition, a discount price or a discount rate may be determined by trip distances for the service provider to visit customers to perform the requested services according to an aspect of the present invention.

The incentive for a group order may encourage the other potential customer who have not yet placed an order to consider placing an order before a group discount offer expires according to an aspect of the present invention.

It is understood that the above explained counting method is an example how to count the neighbors' order according to an aspect of the present invention. Thus, the counting method can be varied.

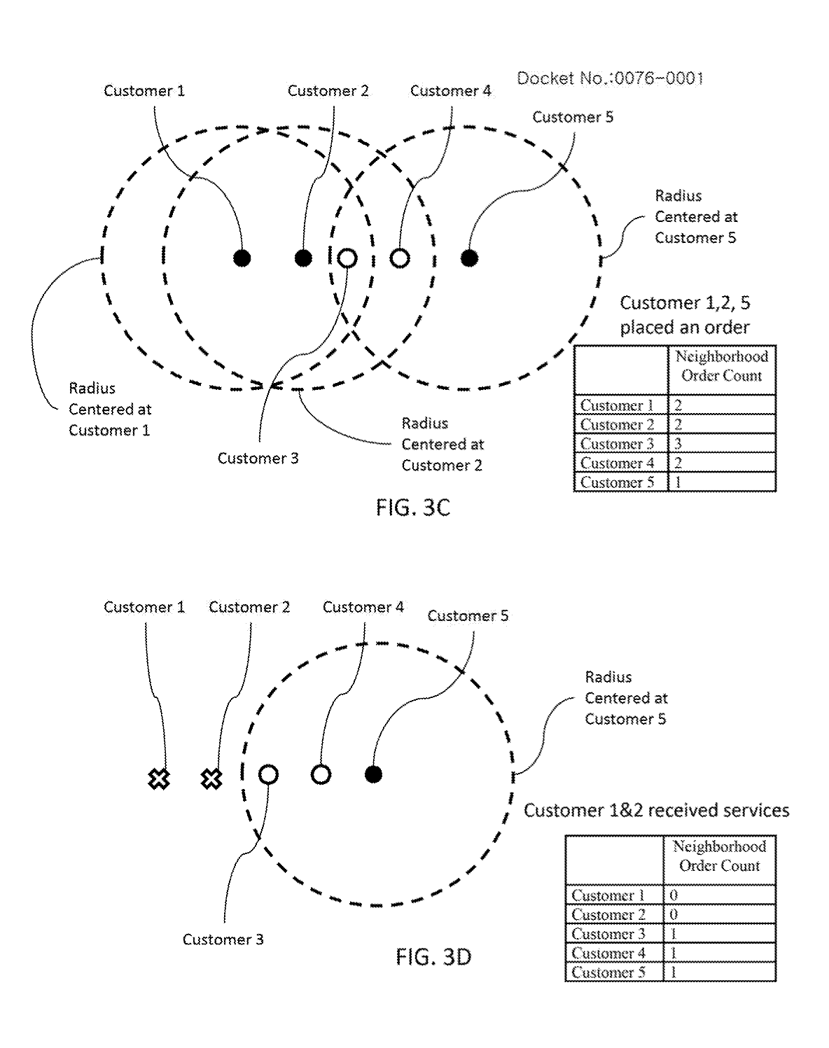

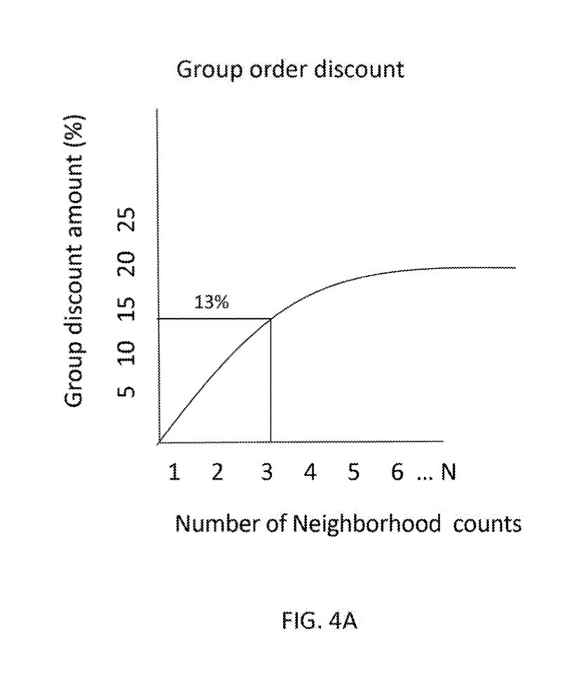

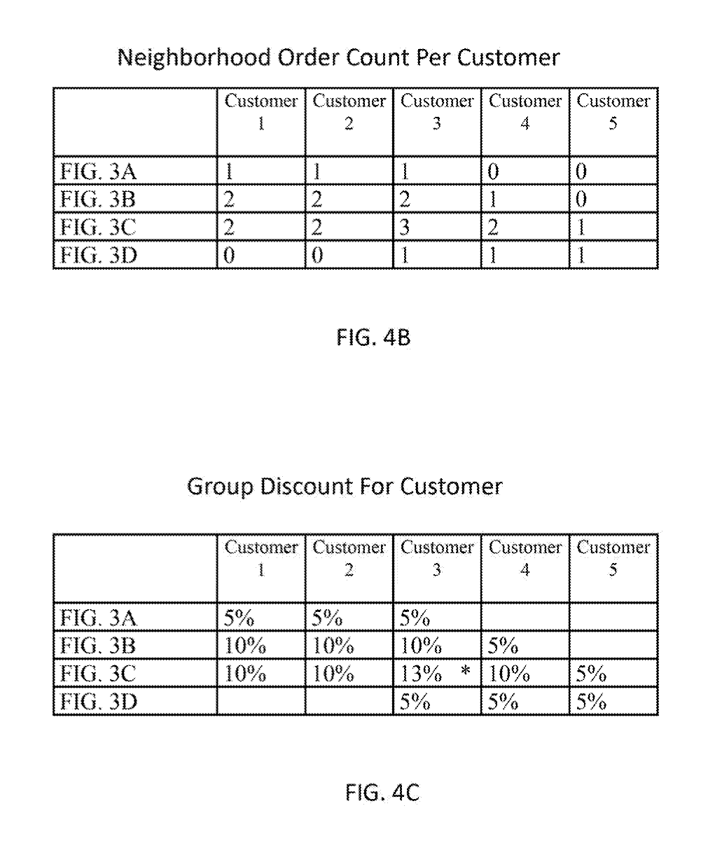

FIG. 4A shows a relationship between a group discount amount (%) and numbers of neighborhood count according to an aspect of the present invention.

FIG. 4B shows a summary of the neighborhood order count per customer mentioned above.

FIG. 4C shows group discount for customers according to examples explained above.

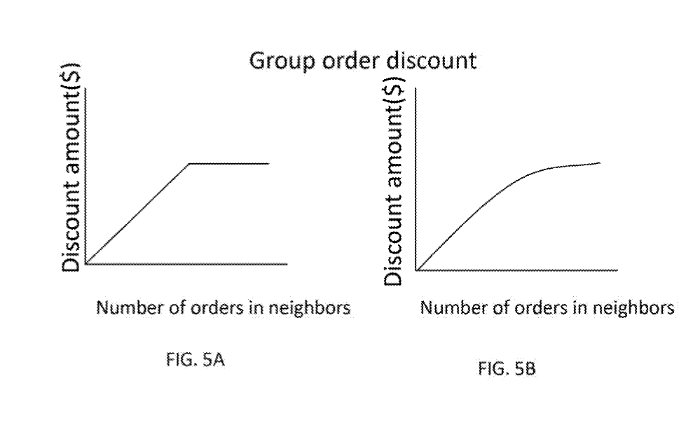

The amounts of discounts and/or rates may be increased linearly as shown in FIG. 5A or increased with a saturation as shown in FIG. 5B. The amount of a group discount for a (registered) user may be linearly increased as the total number of service orders in the area increases until it reaches a predetermined number of orders as shown in FIG. 5A, and then the discount amount may be remained the same or increased very small shown in FIG. 5B. However, it is not limited thereto.

The service orders may be forwarded to a local service provider or providers 204 who are eligible to perform the service if the service orders in a specific area reaches a certain limit, or the group discount offer expires. The system may determine the right number of service providers and dispatch them to the work sites. Since the group order comes from a specific area, the system may find the most efficient route for each local service provider to visit the work sites with a minimum trip distance. However, it is not limited thereto.

Thus, a method for providing group discount offer may include transmitting, via the communication network, a discount service offer to at least one of a plurality of potential users who does not requested the service yet wherein the group discount offer including a discount rate or a discount price. However, it is not limited thereto.

In addition, a method of a group discount offer may further include receiving, via the communication network, a service request from the at least one of the pluralities of potential users; calculating a second discounted prices or a second discount rates for the plurality of the potential users based upon the number of requested services in geographical regions; and informing, via the communication network, the second discounted price or the second discount rate to at least one of the requested pluralities of potential users.

According to aspect of the present invention, the method of a group discount offer may provide the calculating the second discounted price or the second discount rate for the service is determined based upon the number of requested services in the geographical region.

According to aspect of the present invention, the method of a group discount offer may provide the discount price, or the discount rate is high if more numbers of the service are requested in the same geographical region.

According to aspect of the present invention, the method of a group discount offer may further provide recalculating the first discounted price or the first discounted rate for the service request based upon the number of requested service and the geographical region; informing, via the communication network, the recalculated first discounted price or the recalculated first discount rate to the at least one of the pluralities of the users.

According to aspect of the present invention, the method of a group discount offer may provide service is any one of lawn mowing, leaf removal, snow blowing, driveway coating service.

According to aspect of the present invention, the method of a group discount offer may further include requesting, via the communication network, at least one local service provider to perform the requested service.

According to aspect of the present invention, the method of a group discount offer may further include receiving, via the communication network, at least one photo related to service performed by the local service provider.

FIG. 5 illustrates group discount amount based on the number of users' orders in their geographical regions as shown in FIG. 4 according to an aspect of the present invention.

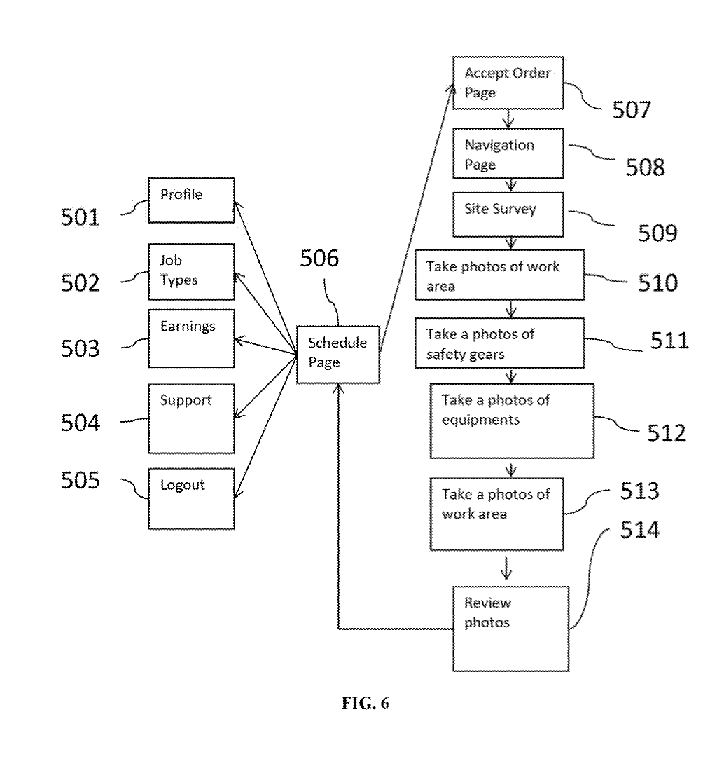

The APP for service provider(s) may include a profile 501, job types 502, earnings 503, support page 504, logout 505, a schedule 506, accept order 507, navigation page 508, site survey 509, take photos of before-work 510 photos of safety gear 511, photos of equipments512, photos 513 of after-work 513, and/or a review page 514 as shown in FIG. 6 according to an aspect of the present invention. The profile page 501 may contain service provider's government id, login, email address, name, phone number, vehicle plate number, home address, bank account, and/or tax id. The job types page 502 may contain the photos of provider's face, vehicle, vehicle license plate, and/or equipment for performing a specific job. The job types page 502 also may contain work eligibility status for each work type, a preferred work area, and/or service provider's own price rate for each work type. The earning page 503 may show locations of work performed, the work type, the serviced time, and/or the amount of earnings. The support page 504 may list frequently asked questions and/or answers of how the APP and system work. The support page 504 may also have a text field to submit questions to the user services.

The local service provider 204 may need to be approved to perform services from the service provider 130. The local service provider 204 may need to supply necessary certifications and licenses for approval from the service provider 130. The certification and licenses may include pictures of their government id, face, work vehicle, vehicle's license plate, and/or equipment for the services. The approval of work eligibility for each work types may be determined by service provider 130, and get reflected on the provider's APP. The local service provider 204 may set a preferred working area where he wants to start his work for a predetermined day. The local service provider 204 may also set service work rates for each job type.

When the local service provider 204 is ready to work for a day, the local service provider 204 may check his APP to see if any jobs have been offered to him in the app's schedule page 506. The schedule page 506 may show provider's serving area, current location, the work site location for a next job, and/or remaining service orders for the day. When a job offered the local service provider 204 either accept or decline the service order 507 based on a size of the job, trip distances, and the types of hazards such as a fence, steep hills, pets, sprinklers, swimming pools which are obstacles to perform jobs for yard and/or driveway services. When accepted, the local service provider 204 may travel to the work site according to the driving directions on the navigation page 508.

Once the local service provider 204 arrives at the job site, he may answer to brief site-survey questionnaires 509 to validate the existences of hazards at the work site.

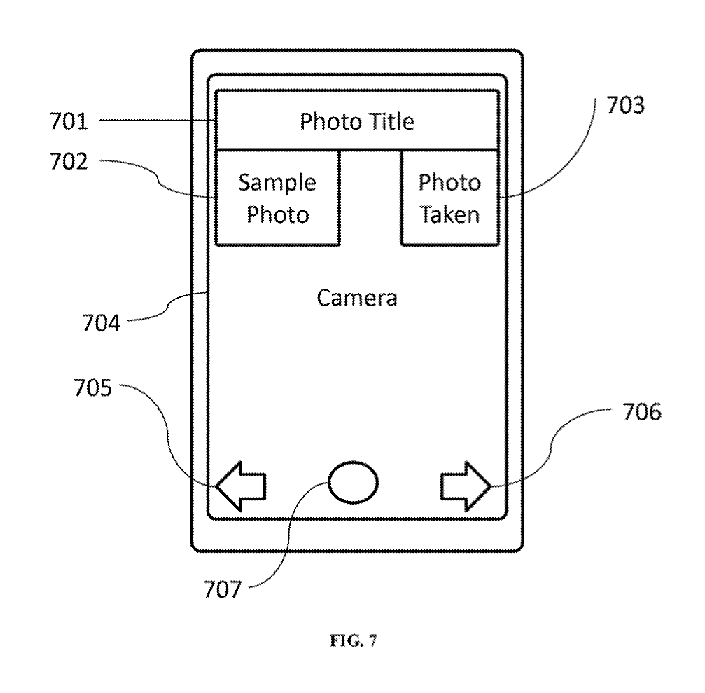

For the preparation of job, the local service provider 204 may take a series of photos to save for the record of job preparation for the work site. The local service provider 204 may need to take several photos of the work area 510, provider's safety gears 511 such as wearing protective glasses, work boots, and work equipment 512 according to the photo instructions 701 of FIG. 7. Then, the job preparation may be transmitted to the server 100, and it may notify the user of the job progress. After the service order has been fulfilled, the local service provider 204 may take a few photos 513 of the work site showing that the job has been completed. The local service provider 204 may review the photos 514 for the quality of his own work to be confirmed. The photos may be delivered to the user to review the completed work.

The photos may be taken by the camera page or a camera mode of the phone 122 of the local service provider as shown in FIG. 7. The photos may be taken sequentially under predefined instructions displayed on the camera screen of the phone 122. A sample image 702 of what needs to be taken may be displayed at one corner or side in the camera view. The image 703 which has been taken may be displayed at another corner or side of the camera page view. By pushing the photo capturing button 707 on the camera view a photo may be taken and saved it on the storage, and then make the camera ready for a next photo by showing the next sample image, switching camera facing, and refocusing.

The camera lens (not shown) of the phone 122 can be focused by tapping on any camera view to be taken. And also the photos can be retaken by forwarding or backwarding to the other camera page by tapping on the left 705 and the right 706 arrow buttons.

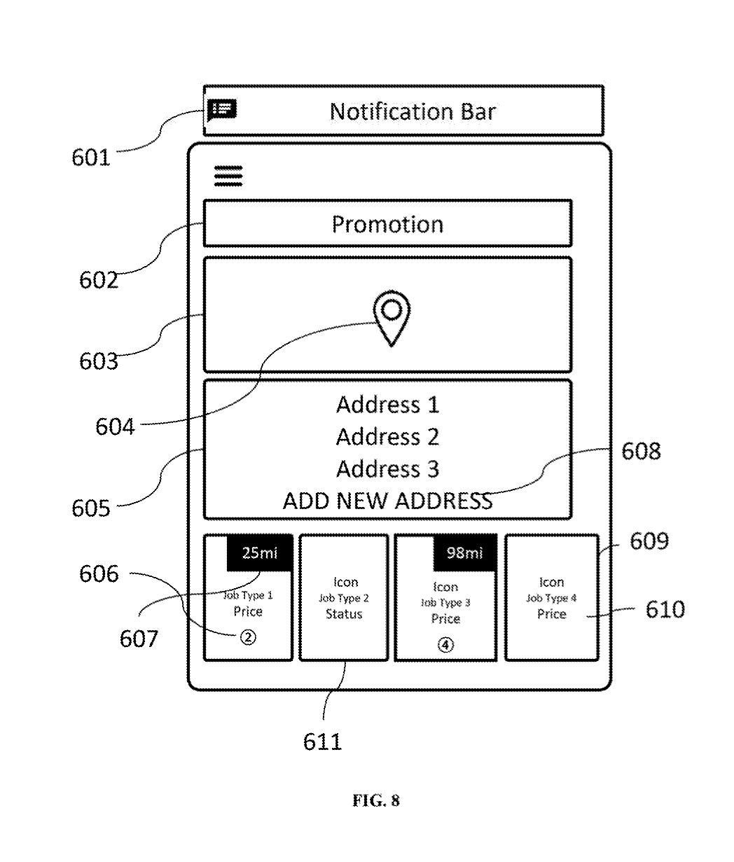

FIG. 8 shows the graphical user interface of the user's APP according to an aspect of the present invention. It may contain a work site location on a map 603, addresses of the user's work sites 605, and service types offered 609 for the sites. The map may be zoomed in/out and panned as needed. Multiple clickable addresses are shown in the address list and a “Add New Location” button 608 may be shown at the end of the address list. As one of the addresses is selected the selected location may be displayed on the centered of map with a marker pin 604. Furthermore, a price quote 610, users' order count 606 in the area, and a remaining time 607 of the group discount offer for the each service for the sites are displayed. When an order for a specific service is placed the APP may show the order status 611 instead of a service price quote. Also, the server 203 may send a push notification of a group discount offer to prospective users in the same geographical area. The group discount offer 601 may be shown up on the notification bar in prospective users' smartphone. The brief description of promotions 602 may be displayed on the APP. The users' order count 606 may be a numerical or text representation of how many service orders have been currently placed from the users within the geographical area. Alternatively, a discount rate that is calculated based on the number of service orders can be presented.

Accordingly, it should be understood that above-described embodiments are essentially for illustrative purpose only but not in any way for restriction thereto. Thus, the scope of the disclosure should be determined by the appended claims and their legal equivalents rather than the specification, and various alterations and modifications within the definition and scope of the claims are included in the claims.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method on a server for providing a discount service and a discount offer for a plurality of users based upon a geographical region over a communications network, comprising:
receiving, from mobile computers communicatively coupled with the communications network, enrollment data of a plurality of users, wherein enrollment data includes at least contact information and service location information of a user;
receiving, via the communications network, a service request from a plurality of the users;
calculating a first discounted price or a first discount rate for the service request based upon the number of requested service and the geographical region;
informing, via the communication network, the first discounted price or the first discount rate to at least one of the pluralities of the users.

2. The method of claim 1, wherein the discount price or the discount rate is high if more number of the service are requested in the same geographical region.

3. The method of claim 1, wherein the discount price or the discount rate is determined by a trip distance among the plurality of users for providing the requested service.

4. The method of claim 1, further comprising: transmitting, via the communication network, a discount service offer to at least one of a plurality of potential users who does not requested the service yet.

5. The method of claim 1, further comprising: receiving, via the communication network, a service request from the at least one of the pluralities of potential users;
calculating a second discounted prices or a second discount rates for the plurality of the potential users based upon the number of requested services in geographical regions; and
informing, via the communication network, the second discounted price or the second discount rate to at least one of the requested pluralities of potential users.

6. The method of claim 1, wherein the calculating the second discounted price or the second discount rate for the service is determined based upon the number of requested services in the geographical region.

7. The method of claim 5, wherein the discount price or the discount rate is high if more numbers of the service are requested in the same geographical region.

8. The method of claim 5, further comprising:
recalculating the first discounted price or the first discounted rate for the service request based upon the number of requested service and the geographical region;
informing, via the communication network, the recalculated first discounted price or the recalculated first discount rate to the at least one of the pluralities of the users.

9. The method of claim 1, wherein the requested service is any one of lawn mowing, leaf removal, snow blowing, driveway coating service.

10. The method of claim 7, wherein the discount price or the discount rate is high if more numbers of the service are requested in the same geographical region.

11. The method of claim 1, further comprising:
requesting, via the communication network, at least one local service provider to perform the requested service.

12. The method of claim 11, further comprising:
receiving, via the communication network, at least one photo related to service performed by the local service provider.

13. A system for providing a discount service and a discount offer for a plurality of users based upon a geographical region over a communications network, comprising:
a server configured to receive, from mobile computers communicatively coupled with the communications network, enrollment data of a plurality of users, wherein enrollment data includes at least contact information and service location information of a user and to receive, via the communications network, a service request from a plurality of the users; to calculate a first discounted price or a first discount rate for the requested service based upon the number of requested service and the geographical region; to inform, via the communication network, the first discounted price or the first discount rate to at least one of the pluralities of the users,
wherein the server further comprises a repository configured to store service location information of the user.
